(19) United States
(12) Patent Application Publication
(10) Pub. No.: US 2017/0087802 A1
(43) Pub. Date: Mar. 30, 2017

(54) MULTILAYER PANEL WITH LIGHT TRANSPARENCY PROPERTIES

(71) Applicant: Italcementi S.P.A., Bergamo (IT)

(72) Inventors: Nicola Rizzo, Bergamo (IT); Aronne Carminati, Chignolo d'Isola (IT)

(73) Assignee: Halcementi S.P.A., Bergamo (IT)

(21) Appl. No.: 15/311,943

(22) PCT Filed: May 18, 2015
(86) PCT No.: PCT/EP2015/060886

§ 371 Date: Nov. 26, 2015

(30) Foreign Application Priority Data
May 19, 2014 (IT) MI2014A000910

(51) Int. Cl. B32B 3/26; B32B 13/12

(52) U.S. Cl. CPC B32B 3/266; B32B 13/12; B32B 2307/102; B32B 2307/304; B32B 2307/414

(57) ABSTRACT

The object of the present invention is a multilayer panel with light transparency and thermal insulation properties. The panel comprises a first outermost portion (4), a second outermost portion (5) and a central portion (6) between said two outermost portions. The central portion comprises spacer means that define at least one interspace between the outermost portions (4,5).

### FIELD OF THE INVENTION

The present invention falls within the scope of production of cementitious articles with light transparency properties. In particular, the object of the present invention is a multilayer panel with light transparency and thermal insulation properties.

### STATE OF THE ART

There has been an increase in the demand for cementitious articles with light transparency properties in recent years. In one particularly preferred embodiment, these are in the form of the panels based on cementitious mortar. FIG. 1 shows a panel 2 of a known type that is crossed by elements 5 in transparent material that allows for the transmission of light from a first side 6 to a second side 7 of the panel 2 opposite to the first. These elements 5 constitute portions of the panel 2 that pass through the entire thickness 9 of the panel itself.

As is known, there are different methods for producing these panels. In general, these methods provide for light transparent elements to be arranged inside a formwork into which the cementitious mortar is subsequently casted to obtain a cementitious item within which the elements of light transparent material remain incorporated. This manufactured item is subsequently finished so as to obtain the desired panel. Example embodiments of these panels are, for example, described, in patent applications EP 2376718, M12013A000790, M12013A000486 filed in the name of the Applicant.

It has however been found that these panels do not have acceptable acoustic and thermal insulation capacities or, in any case, such as to make them widely usable. Indeed their use is currently limited to applications in which thermal and/or acoustic insulation is not a determining aspect. It follows that in all those cases in which there is a real need to thermally and/or acoustically insulate two environments, the use of these panels is not even taken into consideration, thus renouncing from the beginning to the light transmission capacity offered by them. Panels containing layers of plastic foam have been proposed so as to increase the thermal and acoustic insulation properties. Patent application EP 1970179 B1, for example, shows a method for producing a panel that provides for a layer of insulating material provided with openings for the passage of light transparent elements to be arranged so as to substantially define an inner structure of the panel. This structure is inserted into a formwork into which the cementitious mortar is subsequently cast, arranged on two opposite sides of the plastic foam layer. A multilayer panel is thus obtained wherein the plastic foam constitutes a substantially central layer.

The process described in EP1970179 therefore aims to reduce the thermal conductivity of the panel. It is however clear that such a solution cannot be satisfactory as it is too complex and difficult to achieve. In particular, the preparation step of the layer of insulating material appears inconvenient and difficult to produce at competitive costs. In is observed that the method described in EP1970179 in principle determines an increase in panel thickness so as to reduce the thermal conductivity thereof. As is known, the increase in thickness does not lead to a directly proportional increase of the thermal insulation. Therefore this solution does not appear advantageous beyond a certain value of thickness.

From the above considerations there emerges a need to provide alternative technical solutions that allow the light transmission capacity offered by the cementitious items at issue to be more effectively exploited.

### SUMMARY

The main object of the present invention is to provide a new panel with light transparency properties that allows the drawbacks of the prior art to be overcome. In the context of this object a first main aim is to provide a panel with improved thermal insulation characteristics without renouncing the cability to transmit light radiation through the panel itself. Another aim of the present invention is to provide a panel that is reliable and easy to produce at competitive costs.

This object and these aims are achieved by means of a multilayer panel with light transparency properties, as indicated in claim 1. The panel according to the invention maintains a light transparency as all the layers have this property. The presence of at least one defined interspace between the two outermost portions of the panel gives the panel a larger thermal insulation capacity. The interspace indeed constitutes a thermal conduction barrier between the two outermost surfaces of the panel. The presence of one or interspaces inside the panel also advantageously allows the acoustic insulation to be increased with respect to traditional solutions. The panel according to the invention is also easy to assemble at extremely competitive costs.

### LIST OF DRAWINGS

Further characteristics and advantages will become clear from the following detailed description of the method of producing the cementitious items according to the present invention, illustrated by way of a non-limiting example by means of the accompanying drawings, wherein:

FIG. 1 is a perspective view of a panel known to the prior art;

FIG. 2 is a cross-sectional view relating to a first embodiment of a multilayer panel according to the present invention;

FIG. 3 is a perspective view of the panel of FIG. 2;

FIG. 4 is an exploded view of the panel of FIG. 2;

FIG. 5 is a cross-sectional view relating to a second embodiment of a multilayer panel according to the present invention;

FIG. 6 is a perspective view of the panel of FIG. 5;

FIG. 7 is an exploded view of the panel of FIG. 5;

FIG. 8 is a cross-sectional view relating to a third embodiment of a multilayer panel according to the present invention;

FIG. 9 is a perspective view of the panel of FIG. 8;

FIG. 10 is an exploded view of the panel of FIG. 8;

FIG. 11 is a cross-sectional view relating to a fourth embodiment of a multilayer panel according to the present invention;

FIG. 12 is a perspective view of the panel of FIG. 11;

FIG. 13 is an exploded view of the panel of FIG. 11;

FIG. 14 is a cross-sectional view relating to a fifth embodiment of a multilayer panel according to the present invention;

FIG. 15 is a perspective view of the panel of FIG. 14;

FIG. 16 is an exploded view of the panel of FIG. 14;

FIG. 17 is a cross-sectional view relating to a sixth embodiment of a multilayer panel according to the present invention;

FIG. 18 is a perspective view of the panel of FIG. 17;

FIG. 19 is an exploded view of the panel of FIG. 17;

The same numbers and the same reference letters in the drawings identify the same elements or components.

### DETAILED DESCRIPTION

The present invention therefore relates to a multilayer panel with light transparency properties and with improved thermal insulation properties Panel 1,1′,1″,1′″,111,111′ according to the invention comprises a first outer surface 21 and a second outer face 22 opposite to said first outer surface 21. For the purposes of the present invention, the outer surfaces 21,22 substantially indicate the two opposing faces of the panel 1,1′,1″,1′″,111,111′ having greater extension.

The two outer surfaces 21,22 are preferably parallel to each other. Panel 1,1′,1″,1′″,111,111′ according to the invention comprises a first portion 4 outermost that extends between the first outer surface 21 and a first inner surface 21′ that is preferably parallel to the first outer surface 21. This first portion 4 has light transparency properties, i.e. properties such that light can be transmitted from the first outer surface 21 to the first inner surface 21′ and vice versa. The first portion 4 comprises at least one first layer 10 made of composite material based on cementitious mortar that defines at least the first outer surface 21 of the panel 1,1′,1″,1′″,111,111′. The first layer 10 comprises first inner portions 55 that pass through the layer itself through the entire thickness thereof evaluated according to a reference direction 300 orthogonal to the first outer surface 21 and to the second outer surface 22.

Panel 1,1′,1″,1′″,111,111′ according to the invention moreover comprises a second outermost portion 5 that extends between the second outer surface 22 and a second inner surface 22′ that is preferably parallel to the second outer surface 22. Analogously to the first portion 4, the second portion 5 also has transparency properties such as to allow light transmission from the second outer surface 22 to the second inner surface 22′ and vice versa.

The second portion 5 also comprises a first layer 20 made of composite material based on cementitious mortar that defines at least the second outer surface 22 of the panel 1,1′,1″,1′″,111,111′. The first layer 20 of the second portion 5 has a substantially analogous configuration to that of the first layer 10 of the first portion 4. In detail, the first layer 20 of the second portion 5 comprises second inner portions 155 that pass through the layer itself layer through entire thickness thereof, again evaluated according to the reference direction 300 indicated above. The panel 1,1′,1″,1′″,111,111′ according to the invention also comprises a third portion 6 (hereinafter also referred to as “central portion 6”) comprised between the first portion 4 and the second portion 5. This central portion 6 comprises spacer means that are configured to define at least a first interspace 11 between the first portion 4 and the second portion 5 of the panel 1. For the purposes of the present invention, the term “interspace” generically indicates a gap for air or other gas that is, in any case, interposed between the first portion 4 and the second portion 5.

In the context of the present invention, the thickness of an interspace is evaluated as the extension along the above-defined reference direction 300. Similarly, the thickness of portions 4,5,6 of the panel 11,1″,1′″,111,111′, as well as the thickness of any other layers constituting the portions themselves, is also evaluated according to this reference direction 300.

The presence of one or more interspaces defined between the outermost portions 4,5 of the panel 1,1′,1″,1′″,111,111′ gives thermal insulation properties. Indeed, the transmission of heat between first portion 4 and second portion 5 can only occur by means of irradiation and/or by means of convection. When the panel 1,1′,1″,1′″,111,111′ is used as a separation structure between two environments at a different temperature, each interspace defined within the central portion 6, as a matter of fact, constitutes a thermal barrier that advantageously limits dispersion through the panel itself.

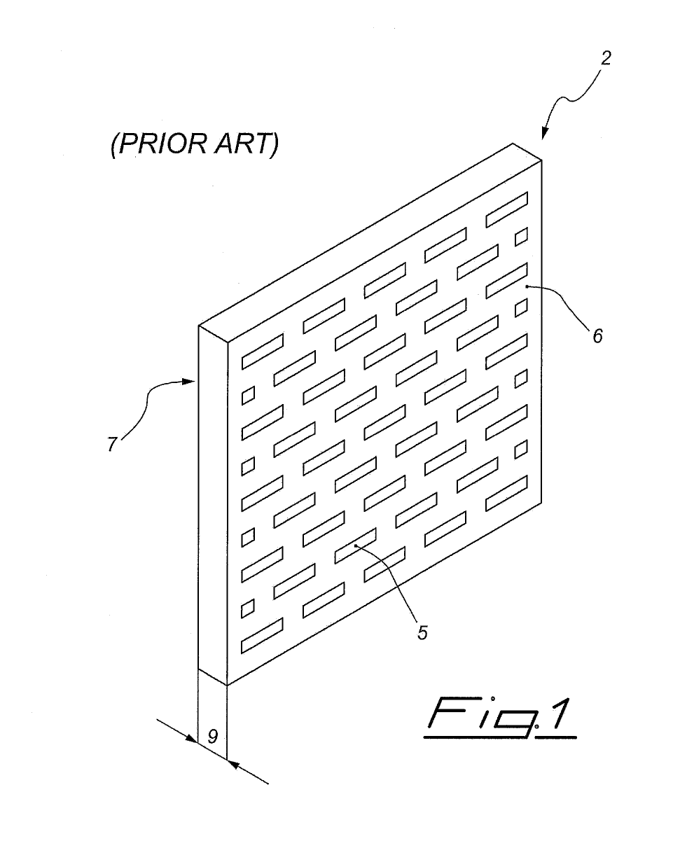

For each of the two outermost portions 4,5, the corresponding first layer 10,20 can advantageously have an analogous structure to the one shown in FIG. 1. More specifically, for each of the portions 4,5, the inner portions 55, 155 of the corresponding layer 10,20 are preferably made of glass, PMMA, polyamide or other transparent material.

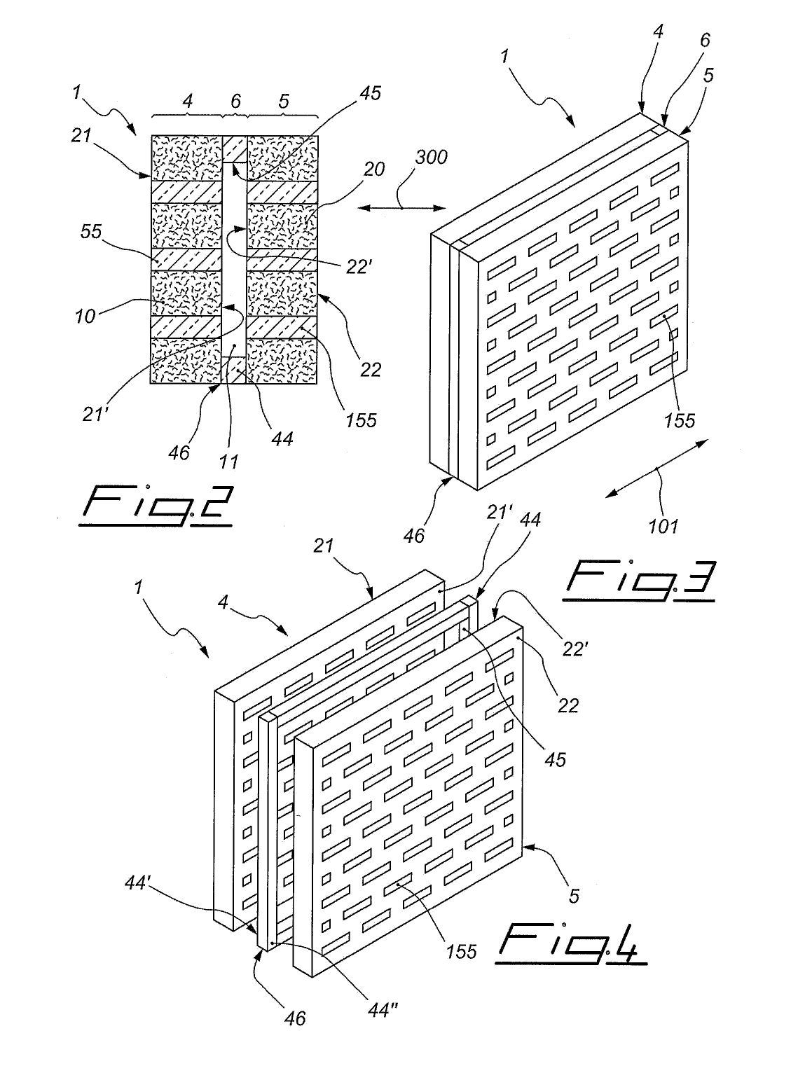

With reference to the structure of FIG. 1, the inner portions 55, 155 of the two layers 10,20 preferably, but not exclusively, have a rectangular section evaluated with respect to a section plane parallel to the outer surfaces 21, 22 of the panel 1,1′,1″,1′″,111,111′. The inner portions 55,155 are preferably arranged according to rows parallel to a first reference direction 101 (indicated for example in FIG. 3) according to an arrangement that is, in itself, know. Again, according to a preferred arrangement, the inner portions 55,155 of each row are arranged so as to be in a staggered position with respect to the inner portions 55′,55″ of the rows thereto.

For the purposes of optimising light transmission through panel 1,1′,1″,1′″,111,111′, the above-indicated two layers 10,20 are configured in such a way that each of the inner portions 55 of the first layer 10 of the first portion 4 is aligned with a corresponding inner portion 155 of the first layer 20 of the second portion 20 according to the reference direction 300.

FIGS. 2 to 4 show a first embodiment of a panel according to the invention indicated with reference 1. With reference to FIG. 2, the first layer 10 of the first portion 4 defines the first inner surface 21′ and the second layer 20 of the second portion 5 defines the second inner surface 22′. In other words, in this first embodiment, the first portion 4 and the second portion 5 of the panel 1 have a substantially “single layer” configuration, being in other words respectively defined by a single layer 10,20 made of composite material based on cementitious mortar as indicated above.

The first inner surface 21′ and the second inner surface 22′ are therefore mutually facing and are separated by an interspace 11, which thickness, measured according to the reference direction 300, substantially coincides with the distance between the inner surfaces 21′, 22′ themselves. It follows that the thickness of the interspace 11 substantially coincides with that of the third portion 6.

In the solution illustrated in FIGS. 2 to 4, the spacer means are physically interposed between the first inner surface 21′ and the second inner surface 22′. These spacer means comprise a plurality of spacer elements that define a peripheral frame 44 between the first portion 4 and the second portion 5 of the panel 1. More precisely, a first side 44′ of said elements of the frame 44 is glued to the first inner surface 21′ of the first portion 4, while a second side 44″, opposite to the first 44′, is glued to the second inner surface 22′ of the second portion 5 of the panel 1. In this regard, an adhesive substance, such as isobutyl glue for example, is used for the gluing.

The elements of the peripheral frame 44 can be made of aluminium or alternatively of a material having high thermal insulation (i.e. with low thermal conductivity) that can, for example, be the material commercially known as TGIO. These elements have a thickness in a range normally between 6 mm and 32 mm. Moreover, these can be in tubular in shape or be internally hollow. In this case, the hollows of the tubular elements can advantageously contain dehydrating salts useful for preventing condensation phenomena inside the interspace externally defined by the elements themselves.

From the above, it emerges that interspace 11 is therefore defined by a volume delimited by the inner surfaces 21′,22′ of the two portions 4,5 of the panel 1 and by the inner sides 45 of the elements of the frame 44. The interspace 11 is externally sealed by means of a sealing substance. For the purposes of the present invention, and in the case in which the interspace 11 is defined between two surfaces made of cementitious material (such as in the embodiment shown in FIGS. 2 to 4 for example), then a two-component epoxy sealing substance can be used. On the other hand, in the case in which an interspace is defined between two glass surfaces (such as in the embodiment in FIGS. 8 to 10 for example), then a polysulphide sealant can be used.

With specific reference to the exploded view of FIG. 4, the frame 44 extends in a manner corresponding to the extension of the inner surfaces 21′,22′, therefore each element of the frame 44 is positioned in correspondence with the opposite edges of the inner surfaces 21′,22′. The elements of the frame 44 have a thickness, measured along the reference direction 300, that substantially coincides with the thickness of the central portion 6 of the panel 1. It is therefore observed that by effect of gluing to the two inner surfaces 21′,22′, the frame 44 makes first portion 4 of the panel 1 integral to the second portion 5 other than defining the interspace 11.

In this embodiment, air, which thus acts as an insulating means between the first portion 4 and the second portion 5, is preferably provided within the interspace 11. FIGS. 5 to 7 relate to a second embodiment of a panel according to the invention indicated with reference 1′. This second embodiment differs from the previous embodiment (FIGS. 2-4) in that the central portion 6 is configured in such a way as to define two interspaces 11,12 between the first portion 4 and the second portion 5. These interspaces 11,12 are separated by a central layer 30 made of light transparent material. For the purposes of the present invention, the central layer 30 is defined by a body made of transparent material in plate form comprising a first face 30′ and a second face 30″. The central layer 30 moreover has a thickness defined as the distance between the two faces 30′,30″ measured according to the reference direction 300 indicated above.

The first interspace 11 is defined between the first inner surface 21′ of the first portion 4 and the first face 30′ of the central layer 30, while the second interspace 12 is defined between the second inner surface 22′ of the second portion 5 and the second face 30″ of the central layer 30 opposite to the first face 30′. Preferably the two interspaces 11, 12 have the same thickness. In this regard, the first portion 4 and the second portion 5 also have the same thickness so that panel 1′ has an overall symmetrical configuration with respect to a central plane of symmetry 301 (indicated in FIG. 5) parallel to the outer surfaces 21,22 of the panel itself.

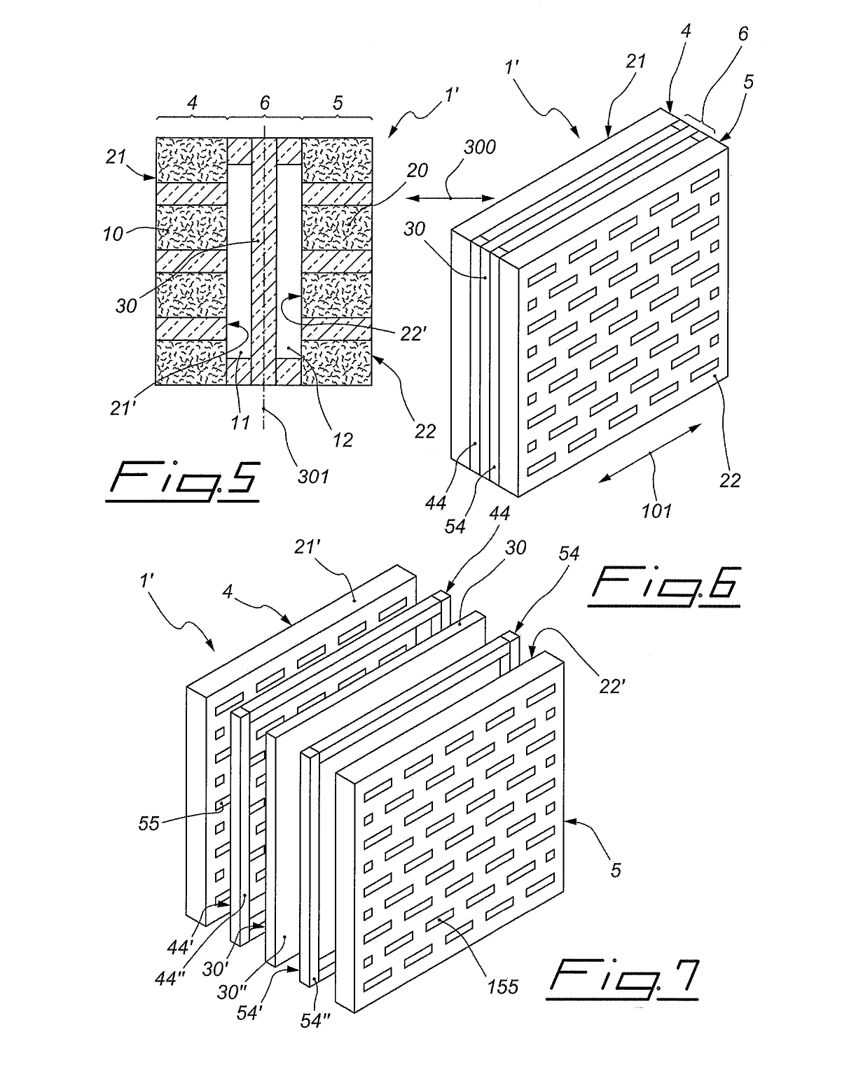

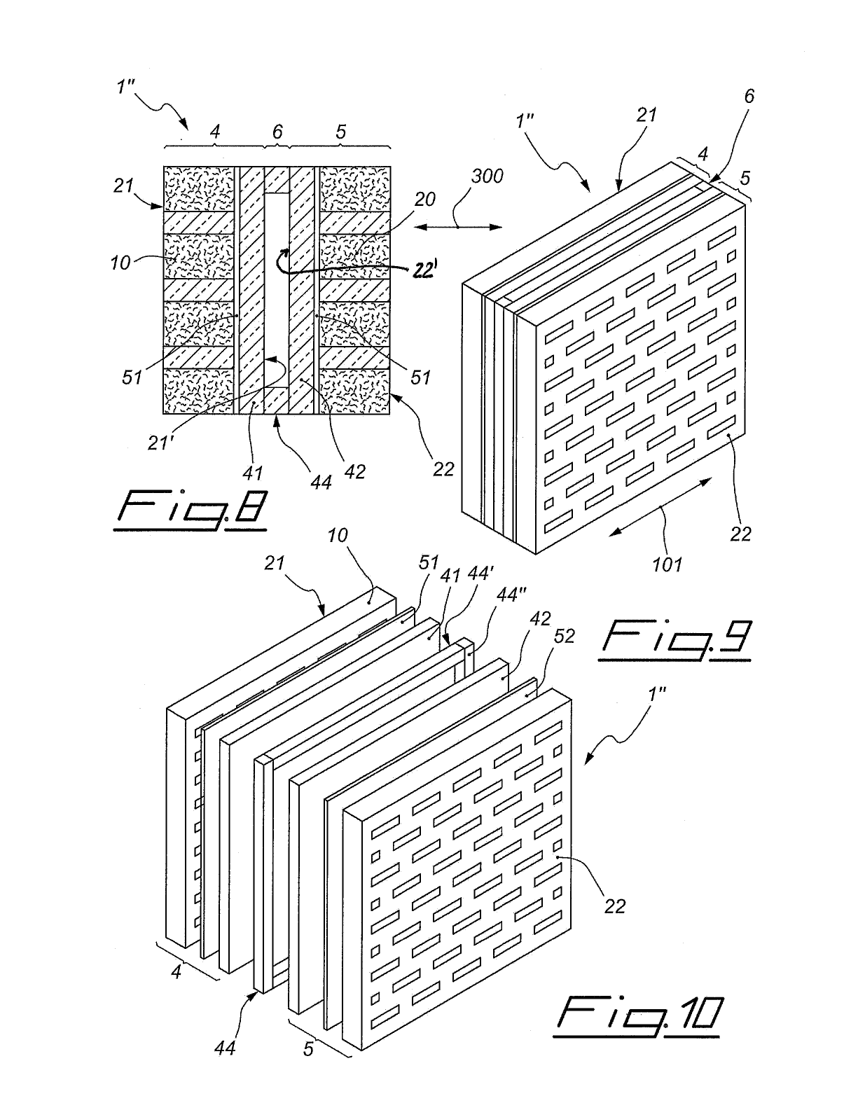

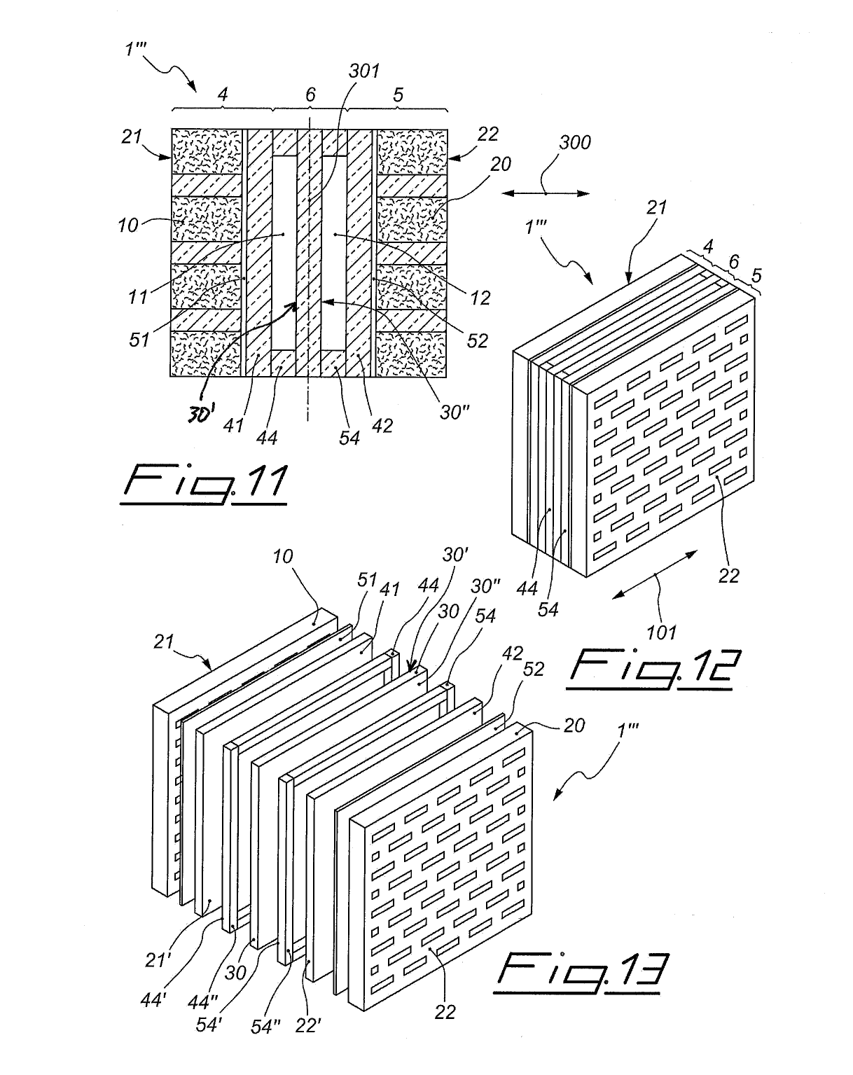

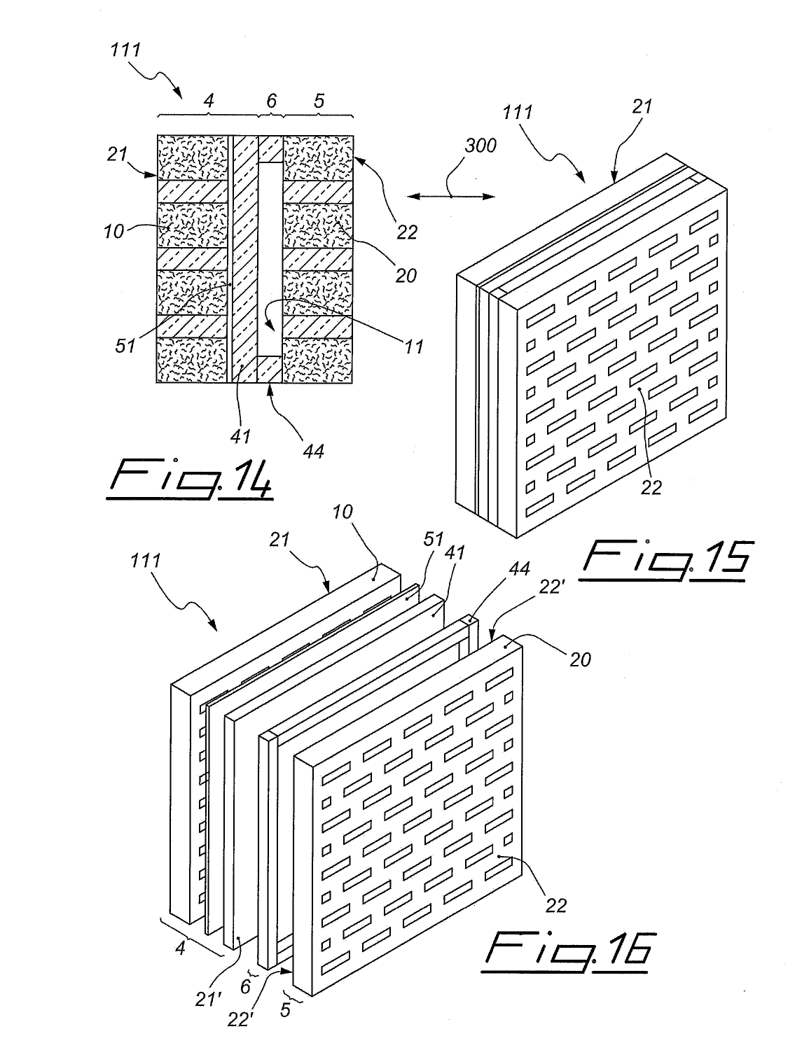

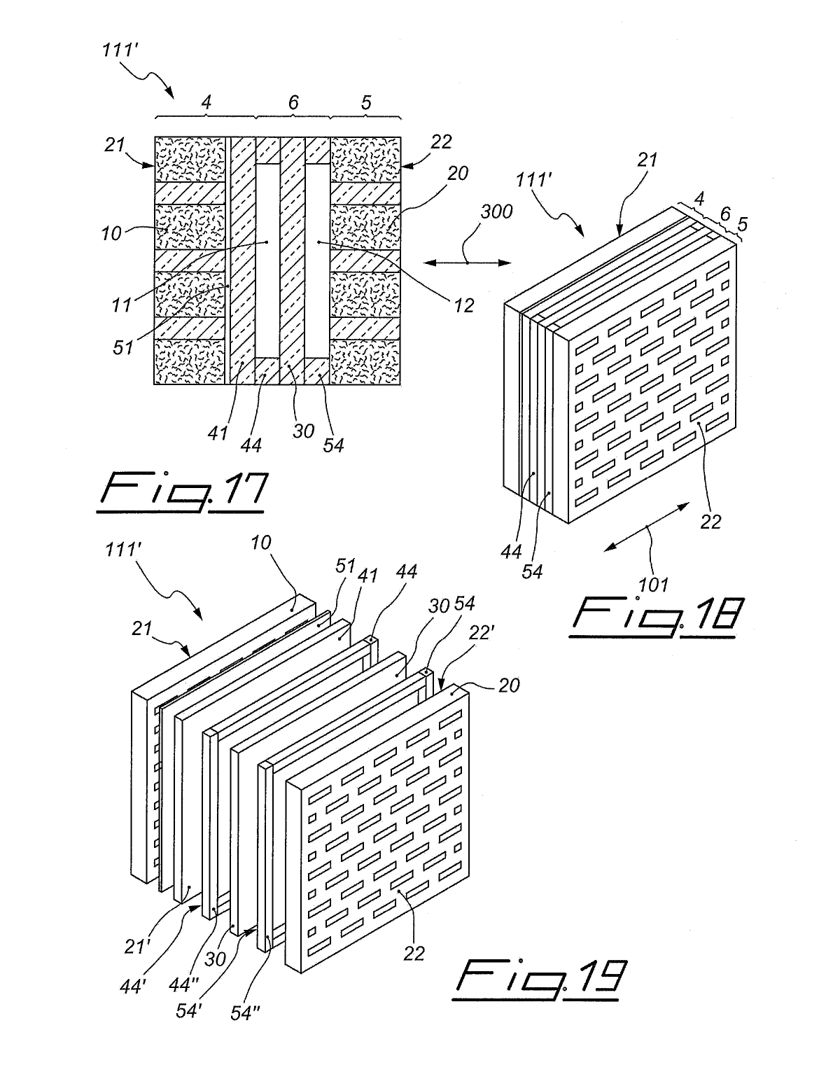

With specific reference to the exploded view of FIG. 7, in this second embodiment the spacer means preferably comprise a first plurality of spacer elements that define a first peripheral frame 44 and a second plurality of separating elements that define a second peripheral frame 54. For each element of the first frame 44, a first side 44′ is glued to the first inner surface 21′ of the first portion 4 of the panel 1′, while a second side 44″ is glued to the first face 30′ of the central layer 30. Analogously for each element of the second frame 54, a first side 54′ and a second side 54″ are respectively glued to the second face 30″ of the central layer 30 and to the second inner surface 22′ of the second portion 5 of the panel 1′.

The methods used to glue the elements of the two peripheral frames 54,44 and, where necessary, to seal the two interspaces 11,12 preferably correspond to those described in the comment to the first embodiment. Reference should therefore be made to the corresponding parts of the above-reported description.

The thickness of the central layer 30 is established as a function of the desired level of thermal insulation to be obtained for panel 1 and/or of the type of material used. The central layer 30 could, for example, be made of a glass selected from the group consisting of float base glass, extra-clear glass, low emissivity multilayer glass comprising at least one thermal insulating layer, multilayer glass comprising one reflecting insulating layer, multilayer glass comprising a safety glass layer coupled with a low emissivity glass, tempered glass, decorative glass, screen printed glass and possible combinations thereof. Alternatively, the central layer 30 could be made of a hardening and light transparent thermoplastic material preferably selected from the group consisting of PMMA, PET, PETg, SAN, PS and PVC.

FIGS. 8 to 10 relate to a third embodiment of the panel 1″ according to the present invention that substantially differs from the first embodiment (FIGS. 2-4) substantially due to a different configuration of the outermost portions (first portion 4 and second portion 5). In particular, in this embodiment the first portion 4 comprises a first outermost layer 10, an innermost first layer 41 and an intermediate layer 51 interposed between said first layer 10 and said second layer 41. Analogously, the second portion 5 comprises an outermost first layer 20, an innermost second layer 42 and an intermediate layer 52 interposed between the first outermost layer 20 and the second innermost layer 42.

The first layer 10 of the first portion 4 and the first layer 20 of the second portion 5 respectively define the first outer surface 21 and the second outer surface 22 of the panel 1″. The second layer 41 of the first portion 4 and the second layer 42 of the second portion 5 respectively define the first inner surface 21′ and the second inner surface 22′ of the panel 1″. The outermost layers 10,20 of the two portions 4,5 of the panel 1″ have a structure preferably corresponding to the one shown in FIG. 1 or to the one provided for the two outermost single-layer portions described in the comments to the first embodiment shown in FIGS. 2 to 4. The considerations reported above in this regard therefore apply in this case also. Again, with reference to FIGS. 8 to 10, the second layer 41 of the first portion 4 and the second layer 42 of the second portion 5 can be made from a thermosetting plastic material or of glass. More specifically, in terms of the structure and materials that can be used, for the innermost layers 41,42, the solutions provided and described above for the central layer 30 provided for in the second embodiment described in the comments to FIGS. 5 to 7, shall apply.

According to a first possible embodiment, the intermediate layer 51 of the first portion 4 and the intermediate layer 52 of the second portion 5 are made of a light transparent thermoplastic material which, once subjected to heating, above its temperature, takes on adhesive properties so as to produce adhesion between the two layers 10-41 and 20-42 between which it is interposed. Preferably, said intermediate layers 51,52 are made of a thermoplastic material selected from the group consisting of polyvinyl butyral (PVB), thermoplastic polyurethane (TPU), ethylene vinyl acetate (EVA) and mixtures thereof. In this regard, it has been observed that in the case in which the innermost layers 41,42 are made of glass then the use of PVB as material for the intermediate layers 51,52 appears particularly advantageous.

According to a possible embodiment, the material constituting the intermediate layers 51,52 can have a different shade of colour than the material constituting the inner portions 55,155 of the layers made of cementitious material that form the first layer 10 of the first portion 4 and the first layer 20 of the second portion 5. By varying the shade of colour of the intermediate layers 51,52 with respect to that of the inner portions 55,155 it is advantageously possible to obtain different visual effects without intervening on the manufacturing method of the first layer 10,20 of the outermost portions 4,5 of the panel.

Each of the outermost portions 4,5 of the panel 1″ is produced by means of a method that provides for a first step wherein the panel 1 is assembled by superimposing and pressing together the layers 10-51-41 and 20-52-42 that define the portion itself. In the case of the first portion 4 for example, the intermediate layer 51 is interposed between the first layer 10 and the second layer 41. During assembly of the first portion 4, the intermediate layer 51 is therefore pressed between the first layer 10 and the second layer 41. This operation therefore determines a first cohesion between the layers 10-51-41 that is subsequently reinforced by means of a heating step with a controlled temperature and pressure. Indeed, once assembled, the first portion 4 is heated, under pre-established pressure conditions, at a temperature that is greater than the glass transition temperature of the thermoplastic material that forms the intermediate layer 51 until adhesion of the second layer 41 with the first layer 10 is achieved. In other words, following heating at a regulated pressure, the intermediate layer 51 in fact acts as an adhesive layer between the first layer 10 and the second layer 41, while however maintaining the light transparency characteristics. Light transmission between the outer face 21 and the inner face 21′ of the first portion 4 is thus guaranteed. At the same time, the presence of the second layer 41 significantly increases the thermal insulation capacity. The second portion 5 of the panel 1″ is assembled in an analogous manner to the first portion 4.

According to an alternative embodiment, the intermediate layer 51 of the first portion 4 and the intermediate layer 52 of the second portion 5 can be constituted by a film or transparent sheet made of a double-adhesive material or even by a layer of single-component or two-component transparent glue (epoxy or polyurethane glue for example) or solvent based glue (methacrylic glue for example). In this case therefore, the first portion 4 and the second portion 5 can be assembled by means of a substantially “cold” process that does not require pre-established temperature and pressure conditions.

In the solution illustrated in FIGS. 8 to 10, the central portion 6 of the panel 1″ has a configuration substantially corresponding to the one provided in the first embodiment described above. Indeed, the central portion 6 defines an interspace 11 delimited between the first inner surface 21′ of the first portion 4 and the second inner surface 22′ of the second portion 5. The interspace 11 is again in this case advantageously produced by means of a plurality of elements that define a peripheral frame 44 according to the previously indicated principles and methods. Reference should therefore be made to the corresponding part of the above-reported description.

It is observed that in this fourth embodiment, given the materials provided for the innermost layers 41,42 of the two portions 4,5, the elements of the peripheral frame 44 can be glued to the corresponding inner surfaces 21′,22″ by means of butyl glue. The interspace 11 is preferably sealed according to the methods previously set out above, to which reference should be made. Under these conditions, i.e. following sealing, the interspace 11 can be advantageously filled with a specific chemically inert noble gas, such as for example argon, krypton, xenon or mixtures of these gases. This solution allows for a further increase in the thermal insulation capacity of the panel 1″.

FIGS. 11 to 13 relate to a fourth embodiment of a panel according to the present invention indicated with reference 1′″. This embodiment differs from the third embodiment (FIGS. 8 to 10) in that the central portion 6 is configured so as to define two interspaces 11,12 analogously to what is provided for the second embodiment (FIGS. 5 to 7) described above. Indeed, in this fourth embodiment the central portion 6 defines two interspaces 11,12 separated by a central layer 30 made of a light transparent material. As concerns the structural characteristics and the materials that can be used for the central layer 30, reference should be made to what has already been indicated in the comment to the solution shown in FIGS. 5 to 7. With regard to the configurations of the outermost portions 4,5 of the panel 1′″, the same solutions/considerations as described/reported above in the comment to the third embodiment (FIGS. 8 to 10) apply.

With specific reference to FIGS. 11 and 13, the first interspace 11 is defined between the innermost layer 41 of the first portion 4 and a first face 30′ of the central layer 30, while the second interspace 12 is defined between the innermost layer 42 of the second portion 5 and a second face 30″ of the central layer 30 opposite to the first face 30′. In this case also, panel 1 has a symmetrical configuration with respect to a central plane of symmetry 301 (indicated in FIG. 11) parallel to the outer surfaces 21,22. To this end, the two interspaces 11, 12 can, preferably but not exclusively, have the same thickness. Similarly, the two outermost portions 4,5 of the panel 1 can also preferably, but not exclusively, have the same thickness. The thicknesses just indicated are always evaluated with respect to the reference direction 300 already indicated above.

In a similar way to what has already described above, the interspaces 11,12 are in this case also defined by means of spacer means comprising a first plurality of spacer elements that define a first peripheral frame 44, and a second plurality of spacer elements that define a second peripheral frame 54 according to principles analogous to those already indicated above in the comment to the solution shown in FIGS. 5 to 7. In fact for each element of said first plurality, a first side 44′ and a second side 44″, opposite to each other, are respectively glued to the first inner surface 21′ and to the first face 30′ of the central layer 30. Analogously for each element of said second plurality, a first side 54′ and a second side 54″, opposite to each other, are respectively glued to the second face 30″ of the central layer 30 and to the second inner layer 22′.

It is observed that in this fourth embodiment, based on the possible combinations of materials that can be used for the central layer 30 and for the innermost layers 41,42, the two frames 44,54 can be glued to the corresponding surfaces 21′-30′, 21″-30″ by means of butyl glue. Moreover, in this embodiment also, a specific chemically inert gas such as those already indicated above can also be advantageously provided inside the interspaces 11,12.

FIGS. 14 to 16 relate to a fifth embodiment of a panel according to the present invention indicated with reference 111. With respect to the previous embodiments described above, panel 111 has a substantially “asymmetric” inner configuration. In particular, panel 111 comprises a first portion 4 having a “multilayer” structure substantially corresponding to the one provided for the above-described third and fourth embodiments or comprising a first outermost layer 10, a second innermost layer 41 and an intermediate layer 51. On the other hand, the second single-layer portion 5 has a “single-layer” structure corresponding to the one provided in the first and second above-described embodiments, i.e. formed by a single layer of cementitious material with inner portions made of light transparent material. The thickness of the first layer 10 of the first portion 4 is preferably, but not exclusively, substantially equivalent to the thickness of the second portion 5 of the panel 111.

In this fifth embodiment also, the central portion 6 also defines a single interspace 11, preferably containing air, between the two outermost portions 4,5. This interspace 11 is, in this case also, defined by means of spacer means corresponding to those described above as a comment to the first and third embodiments to which reference should be made for economy of description. FIGS. 17 to 19 relate to a sixth embodiment of a panel according to the present invention indicated with reference 111′. The two portions 4,5 of the panel 111′ have a structure corresponding to those provided in the fifth embodiment (FIGS. 14 to 16) described above. On the other hand, the central portion 6 has an analogous configuration to the one provided for the second embodiment (FIGS. 5 to 7) and for the fourth embodiment (FIGS. 11 to 13) described above. Indeed the central portion 6 defines a first interspace 11 and a second interspace 12 separated by a central layer 30. There can therefore be spacer means comprising a first plurality of spacer elements and a second plurality of spacer elements in this embodiment also. In this case the elements of said first plurality are interposed between the first inner surface 21′ of the first portion 4 and a first face 30′ of the central layer 30 so as to define a first peripheral frame 44 that externally delimits the first interspace 11. Analogously, the elements of said second plurality are interposed between the second inner surface 22′ of the second portion 5 and a second face 30″ of the central layer 30 so as to define a second peripheral frame 54 that externally delimits the second interspace 12. The spacer elements and the interspaces 11,12 can be respectively glued and sealed according to methods already described and to which reference should be made.

It is observed that in this embodiment, a specific chemically inert noble gas (argon, krypton or xenon for example), which use is made possible for sealing of the first interspace 11, on the one hand, and for the use of glass or plastic material for the central layer 30 and for the first inner surface 21′ of the first portion 4, on the other hand, is preferably but not exclusively provided inside the first interspace 11. However, given the permeability characteristics of the cementitious material constituting the second portion 5, air is preferably provided in the second interspace 12.

The different embodiments of the above-described panel advantageously allow the set aims and objects to be fully achieved. In particular, with respect to known solutions, the panel according to the invention has major acoustic and thermal insulation capacities while maintaining light transparency properties between the two outermost faces.

1) A multilayer panel with light transparency properties, said panel comprising a first outer surface and a second outer surface opposite to said first outer surface, characterized in that said panel comprises at least:
a first portion of said panel comprised between said first outer surface and a first inner surface, said first portion comprising at least a first layer of composite material based on cementitious mortar, said first layer of said first portion defining at least said first outer face of said panel and comprising inner portions made of translucent material, said inner portions of said first layer of said first portion being passing through the entire thickness of the first layer itself of said first portion;
a second portion of said panel which extends between said second outer surface and a second inner surface, said second portion comprising at least a first layer of composite material based on cementitious mortar, said first layer of said second portion defining said second outer surface of said panel and comprising second inner portions made of translucent material, said inner portions of said first layer of said second portion being passing through the entire thickness of the said first layer itself of said second portion;
a third portion of said panel comprised between said first inner surface of said first portion and said second inner surface of said second portion, said third portion comprising spacing means which define at least a first interspace between said first portion and said second portion of said panel.

2) The panel according to claim 1, wherein said first portion further comprises a second innermost layer and an intermediate layer interposed between said first layer and said second layer, wherein said second innermost layer defines said first inner surface of said first portion of panel.

3) The panel according to claim 1, wherein said second portion further comprises a second innermost layer and an intermediate layer interposed between said first layer and said second layer of said second portion, wherein said second innermost layer defines said second inner surface of said second portion of said panel.

4) The panel according to claim 2, wherein said second innermost layer of said first portion and/or of said second portion is made of glass selected from the group consisting of float base glass, extra-clear glass, low-emissivity multilayer glass comprising at least a thermal insulating layer, multilayer glass comprising a reflective insulating layer, multilayer glass comprising a layer of safety glass coupled to a low-emissivity glass, tempered glass, decorative glass, screen printed glass, and combinations thereof.

5) The panel according to claim 2, wherein said second innermost layer is made of a material selected from the group consisting of PMMA, PET, PETg, SAN, PS, PVC.

6) The panel according to claim 2, wherein said intermediate layer is made of a thermoplastic material selected from the group consisting of polyvinyl butyral (PVB), thermoplastic polyurethane (TPU), ethylene vinyl acetate (EVA) and mixtures thereof.

7) The panel according to claim 2, wherein said intermediate layer is defined by a transparent film of double-adhesive material or even by a layer of transparent glue.

8) The panel according to claim 7, wherein said transparent glue is a glue selected from the group consisting of single-component glue, two-component glue, epoxy glue, polyurethane glue, solvent-based glue, methacrylate glue and combinations thereof.

9) The panel according to claim 1, wherein said spacing means comprise a plurality of spacing elements which define a peripheral frame interposed between said first portion and said second portion of said panel, a first side of said elements of said frame being glued and sealed to said first inner surface, a second side of said elements of said frame being glued and sealed to said second inner surface.

10) The panel according to claim 9, wherein said elements of said frame are glued to said first inner surface and to said second inner surface by means of a butyl-based adhesive substance.

11) The panel according to claim 9 or 10, wherein said frame is externally sealed between said first portion and said second portion by means of a sealing substance.

12) The panel according to claim 9 or 10, wherein said first layer of said first portion defines said first inner surface or wherein said first layer of said second portion defines said second inner surface.

13) The panel according to claim 12, wherein said first layer of said first portion defines said first inner surface and wherein said first layer of said second portion defines said second inner surface.

14) The panel according to claim 1, wherein said spacing means define a first interspace and a second interspace between said first portion and said second portion of said panel, said spacing means comprising a separating central layer which separates said first interspace from said second interspace, said first interspace being defined between said first inner surface of said first portion and a first face of said central layer, said second interspace being defined between said second surface of said second portion and a second face of said central layer opposite said first face.

15) The panel according to claim 14, wherein said spacing means comprise a first plurality of elements glued between said first inner surface of said first portion and said first face of said central layer so as to define a first peripheral frame, said spacing means comprise a second plurality of elements glued and sealed between said second inner surface of said first portion and said second face of said central layer so as to define a second peripheral frame.

16) The panel according to claim 14, wherein one of said inner surfaces is defined by said first layer of one of said portions of said panel.

17) The panel according to claim 14, wherein said innermost separating central layer is made of glass selected from the group consisting of float base glass, extra-clear glass, low-emissivity multilayer glass comprising at least a thermal insulating layer, multilayer glass comprising a reflective insulating layer, multilayer glass comprising a layer of safety glass coupled to a low-emissivity glass, tempered glass, decorative glass, screen printed glass, and combinations thereof.

18) A panel according to claim 15, wherein one of said inner surfaces is defined by said first layer of one of said portions of said panel.

19) A panel according to claim 15, wherein said innermost separating central layer is made of glass selected from the group consisting of float base glass, extra-clear glass, low-emissivity multilayer glass comprising at least a thermal insulating layer, multilayer glass comprising a reflective insulating layer, multilayer glass comprising a layer of safety glass coupled to a low-emissivity glass, tempered glass, decorative glass, screen printed glass, and combinations thereof.
